(19) United States
(12) Patent Application Publication
(10) Pub. No.: US 2007/0064341 A1
(43) Pub. Date: Mar. 22, 2007

(54) HARD DISK DRIVE

(76) Inventors: Young Son, Yongin-si (KR); Keiichiro Yoshida, Yokohama-si (JP); Takahiro Tokumiya, Yokohama-si (JP)

Correspondence Address: STANZIONE & KIM, LLP, 919 18TH STREET, N.W., SUITE 440, WASHINGTON, DC, 20006, US

(21) Appl. No.: 11/533,029

(22) Filed: Sep. 19, 2006

(30) Foreign Application Priority Data
Sep. 20, 2005 (JP) 2005-272819
Dec. 22, 2005 (KR) 2005-127793

(51) Int. Cl. G11B 17/00

(52) U.S. Cl. 360/97.01

(57) ABSTRACT

A hard disk drive (HDD) including a disk, a spindle motor to rotate the disk, the spindle motor including a spindle shaft, a plurality of magnetic circuits having cores and coils wound around the cores, the magnetic circuits being installed along a peripheral portion of the spindle shaft, a base plate to support the spindle motor, and an actuator to move a head. The magnetic circuits include a first magnetic circuit installed in an operating region of the actuator, and a second magnetic circuit installed outside the operating region of the actuator. The first and second magnetic circuits have different shapes. The first magnetic circuit has a larger length in a respective core direction thereof parallel to the base plate and the second magnetic circuit has a larger thickness in a direction perpendicular to the respective core direction and perpendicular to the base plate. Thus, a sufficient torque of the spindle motor can be ensured by increasing a number of windings of the wire of the magnetic circuits without increasing an electric current.

### CROSS-REFERENCE TO RELATED APPLICATIONS

This application claims the benefit of Korean Patent Application No. 10-2005-0127793, filed on Dec. 22, 2005, in the Korean Intellectual Property Office, and Japanese Patent Application No. 2005-272819, filed on Sep. 20, 2005, in the Japanese Patent Office the disclosures of which are incorporated herein in their entirety by reference.

### BACKGROUND OF THE INVENTION

1. Field of the Invention

The present general inventive concept relates to a hard disk drive, and more particularly, to a hard disk drive having a structure that can be easily minimized with a thin size and a minimal thickness.

2. Description of the Related Art

Recently, hard disk drives have been included in electronic devices such as mobile phones and media players as data recording media. Since many electronic devices are being made smaller in order to improve portability, the demand for hard disk drives of small size, for example, smaller than 1 inch, has increased.

In order to make a hard disk drive (HDD) small and thin, research for removing unused space in the hard disk drive or for using an inner space more efficiently has been performed. In an effort to achieve these objectives, elements in the hard disk drive may be reshaped. For example, Japanese Laid-open Patent No. 2000-76826 discloses a technology of forming a circular penetration hole accommodating a spindle motor that rotates a disk on a circuit board, on which electronic devices are mounted, in order to reduce a height of the hard disk drive based on a direction of a rotary axis of the disk. The hard disk drive can also be minimized by reducing overlaps of the elements in the HDD.

FIG. 1A is a partial cross-sectional view illustrating a conventional hard disk drive (HDD), and FIG. 1B is an enlarged perspective view illustrating a magnetic circuit 60 of the conventional HDD of FIG. 1A. In addition, FIG. 2 is a plan view illustrating a base plate 30 of the conventional HDD of FIG. 1, and FIG. 3 is a plan view illustrating a circuit board 50 of the conventional HDD of FIG. 1.

Referring to FIGS. 1A and 1B, the conventional hard disk drive includes a spindle motor 10, a disk 20, the base plate 30, an actuator 40, and the circuit board 50. The spindle motor 10 is a driving unit for rotating the disk 20, and may include a disk clamp 15 for clamping the disk 20 down from an upper side of the disk 20, a hub 17 for supporting the disk 20 from a lower side of the disk 20, and a fixing member 13 for fixing the disk clamp 15 onto a spindle shaft 11. In addition, the hub 17 includes a magnet 65 on a portion opposite to the base plate 30, and a plurality of magnetic circuits 60 formed to face the magnet 65.

Referring to FIG. 1B, the magnetic circuit 60 is formed by winding a wire 63 around a core 61. A hole element (not illustrated) is installed in the magnetic circuit 60. The magnet 65 may be formed as a ring, and is installed around the hub 17. The spindle motor 10 rotates when a magnetic field is generated between the magnetic circuit 60 and the magnet 65 by generating a current flow through the wire 63 of the magnetic circuit 60.

The actuator 40 includes a head 45 on an end portion thereof, and the other end of the actuator 40 is rotatably installed on a rotary shaft 43. The base plate 30, which supports the spindle motor 10, and the circuit board 50 are installed under the disk 20.

In the conventional HDD having the structure described above, the magnetic circuit 60 installed in an operating area of the actuator 40 and the magnetic circuit 60 installed outside of the operating area of the actuator 40 have similar sizes. Therefore, there is a larger space under the disk 20 outside of the operating area of the actuator 40 than a space in the operating area of the actuator 40. In addition, a controlling circuit (not illustrated) is not disposed on the circuit board 50 in the operating area of the actuator 40 so as not to interfere with the operation of the actuator 40.

In addition, referring to FIG. 2, a penetration hole 31 is formed in the conventional base plate 30 at a portion where the spindle motor 10 (see FIG. 1A) is inserted. A plurality of installation holes 33, in which the plurality of magnetic circuits 60 (see FIGS. 1A and 1B) are installed, are formed along a peripheral portion of the spindle shaft 11 (see FIG. 1A). A shape of the installation hole 33 corresponds to a shape of the magnetic circuit 60, and the installation holes 33 are formed to be the same size.

In addition, as illustrated in FIG. 3, a circular penetration hole 53 is formed in a portion of the circuit board 50 (see FIG. 1A), where the spindle motor 10 (see FIG. 1A) is inserted.

However, in the conventional HDD having the structure described above, it is physically impossible to increase a number of the winding wires 63 of the magnetic circuit 60 that rotates the spindle motor 10 or to increase a diameter of a stator, when a height of the conventional HDD is reduced. Therefore, a torque of the spindle motor 10 that rotates the disk 20 is reduced. Thus, a large amount of electric current is required in order to ensure that sufficient torque is provided for rotating the spindle motor.

In order to increase the torque of the spindle motor without increasing the electric current, the core 61 of the magnetic circuit 60 may be formed to be thick, the number of windings of the wire 63 on the core 61 of the magnetic circuit 60 may be increased, or the diameter of the stator may be increased for strengthening the magnetic field generated by the magnetic circuit 60.

### SUMMARY OF THE INVENTION

The present general inventive concept provides a compact-sized hard disk drive (HDD) having a spindle motor with a high torque due to an increased number of windings of wire of a magnetic circuit such that electric current supplied to the spindle motor need not be increased.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing a hard disk drive (HDD) including a disk, a spindle motor to rotate the disk, the spindle motor including a spindle shaft, a plurality of magnetic circuits having cores and coils wound around the cores, the magnetic circuits being installed along a peripheral portion of the spindle shaft, a base plate to support the spindle motor, and an actuator to move a head that records and/or reproduces data to/from the disk, wherein the magnetic circuits include a first magnetic circuit installed in an operating region of the actuator and a second magnetic circuit installed outside of the operating region of the actuator. The first magnetic circuit has a different shape than the second magnetic circuit.

The first magnetic circuit has a larger length in a respective core direction parallel to the base plate than the second magnetic circuit, and the second magnetic circuit has a larger thickness in a direction perpendicular to the respective core direction and perpendicular to the base plate.

The base plate may include a first installation hole in which the first magnetic circuit is installed, and a second installation hole in which the second magnetic circuit is installed.

The HDD may further include a circuit board installed on a rear surface of the base plate having a penetration hole with a substantially circular shape formed therein and in which the spindle motor is inserted, and a notch formed in an area of a peripheral portion of the penetration hole corresponding to the first magnetic circuit and into which the first magnetic circuit is installed.

A number of first magnetic circuits and a number of second magnetic circuits may depend on a number phases of the spindle motor.

The foregoing and/or other aspects of the present general inventive concept are also achieved by providing a hard disk drive, including a base plate, a spindle motor disposed on the base plate, a disk to be rotated by the spindle motor, a head stack assembly movable about the disk in an operating portion of the base plate, at least one first circuit having a first shape disposed in the operating portion of the base plate, and at least one second circuit having a second shape different from the first shape disposed in a non-operating portion of the base plate.

The foregoing and/or other aspects of the present general inventive concept are also achieved by providing a hard disk drive, including a base plate having a first penetration hole to accommodate a spindle motor and different size installation holes arranged around a periphery of the first penetration hole, and a circuit board disposed at a rear side of the base plate and having a second penetration hole corresponding to the first penetration hole to accommodate the spindle motor.

The foregoing and/or other aspects of the present general inventive concept are also achieved by providing a spindle motor assembly usable in a hard disk drive, the assembly including a base plate, a rotatable hub disposed on the base plate to support a disk, a magnet disposed around a base of the hub, one or more first magnetic circuits disposed around a first circumferential portion of the hub to generate a first magnetic field with respect to the magnet, and one or more second magnetic circuits disposed around a second circumferential portion of the hub to generate a second magnetic field with respect to the magnet.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1A is a partial cross-sectional view illustrating a conventional hard disk drive (HDD), and FIG. 1B is an enlarged perspective view illustrating a magnetic circuit of the conventional HDD of FIG. 1A;

FIG. 2 is a plan view illustrating a base plate in the conventional HDD of FIG. 1A;

FIG. 3 is a plan view illustrating a circuit board in the conventional HDD of FIG. 1A;

FIG. 4 is a schematic plan view illustrating an HDD according to an embodiment of the present general inventive concept;

FIG. 5 is a plan view illustrating an operating area of an actuator of the HDD of FIG. 4;

FIG. 6A is a partial cross-sectional view illustrating the HDD of FIG. 4;

FIG. 6B is an enlarged perspective view illustrating a first magnetic circuit of FIG. 6A;

FIG. 6C is an enlarged perspective view illustrating a second magnetic circuit of FIG. 6A;

FIG. 7 is a plan view illustrating a base plate of the HDD of FIG. 4, according to an embodiment of the present general inventive concept;

FIG. 8 is a plan view of a circuit board of the HDD of FIG. 4, according to an embodiment of the present general inventive concept; and

FIG. 9 is an exploded perspective view illustrating a base plate and a circuit board of the HDD of FIG. 4, according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

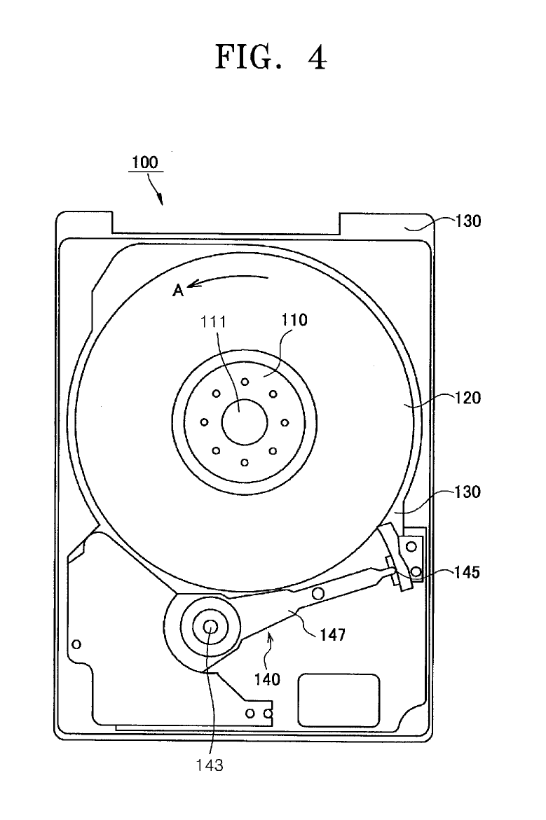

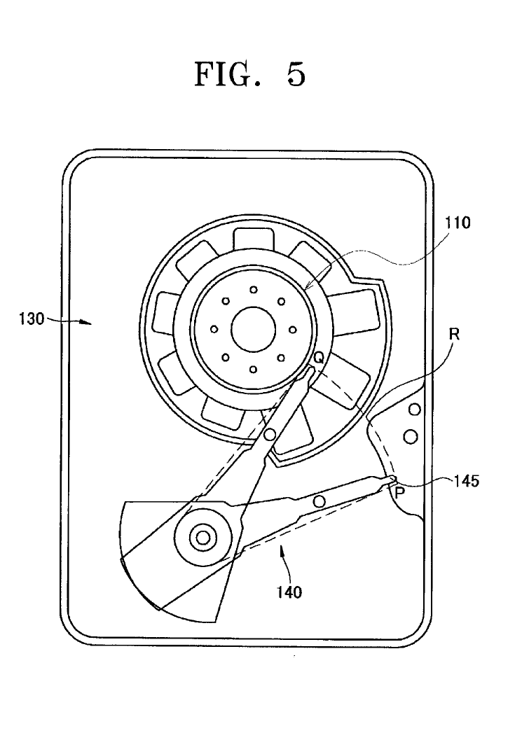

FIG. 4 is a schematic plan view of a hard disk drive 100 (HDD) according to an embodiment of the present general inventive concept, and FIG. 5 is a plan view illustrating an operating region R of an actuator 140 in the HDD 100 of FIG. 4.

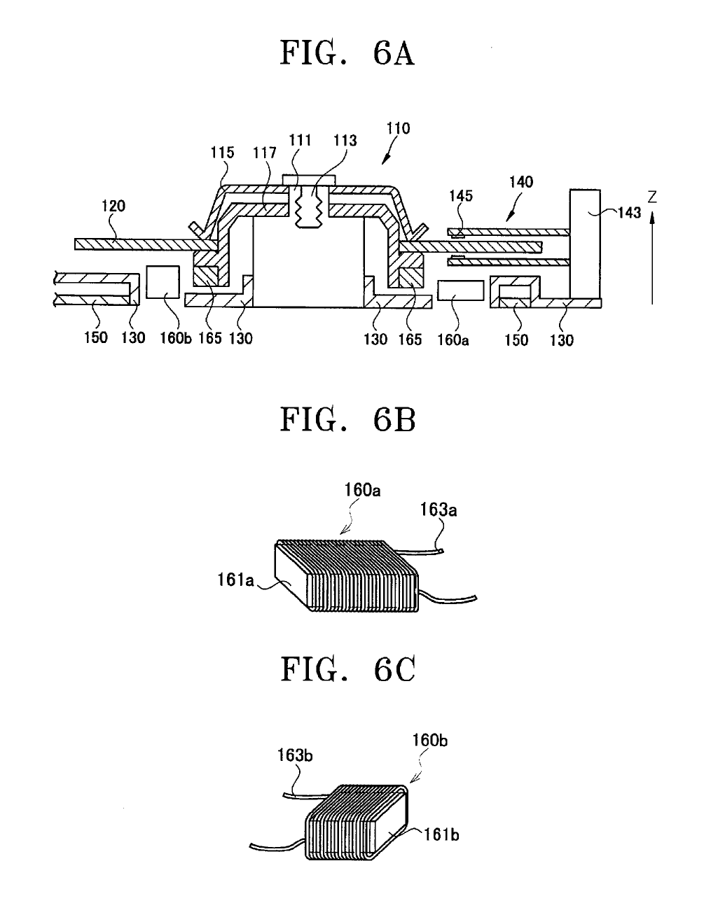

Referring to FIG. 4, the HDD 100 includes a disk 120 (that is, a data recording medium) a spindle motor 110 to rotate the disk 120, a base plate 130 to support the spindle motor 110, the actuator 140 including a head 145 to record and/or reproduce data to/from the disk 120, and a circuit board 150 (see FIG. 6A) including a controlling circuit to control the spindle motor 110 and the actuator 140.

The spindle motor 110 is a motor to rotate the disk 120. A spindle shaft 111 is rotated due to an interaction of magnetic circuits 160a and 160b (see FIGS. 6A to 6C) and a magnet 165 (see FIG. 6A) that will be described below. The disk 120 is fixed by a hub 117 (see FIG. 6A) of the spindle motor 110 and a disk clamp 115 (see FIG. 6A). In the present embodiment, the spindle motor 110 may be a three-phase spindle motor.

The base plate 130 supports the spindle motor 110. The actuator 140 and a pivot 143 to fix the actuator 140 to the base plate 130 may be installed on the base plate 130.

The actuator 140 includes the head 145 to record and/or reproduce the data to/from the disk 120. The actuator 140 also includes a head suspension assembly (HSA) 147 having an end mounted on the pivot 143 and the other end having the head 145 attached thereto. The actuator 140 may include a pair of the HSAs 147 with respect to one disk 120. The pair of HSAs 147 may be stacked with a predetermined interval therebetween, and the disk 120 may be disposed between the HSAs 147 in the interval. When recording and/or reproducing data to/from the disk 120, the head 145 is moved to a predetermined position on the disk 120 by rotating the HSA 147. The actuator 140 may be driven by, for example, a voice coil motor VCM (not illustrated).

In the HDD 100 having the structure described above, the disk 120 is rotated by the spindle motor 110 in a direction represented by arrow A in FIG. 4. In addition, the actuator 140 operates to move the head 145 to the predetermined position on the disk 120 when recording and/or reproducing the data.

Referring to FIG. 5, the actuator 140 can move from a position (P) where the head 145 is positioned at an outer circumference of the disk 120 to a position (Q) where the head 145 is positioned at an inner circumference of the disk 120 (that is, within an operating region (R)). The operating region R is represented by a dashed outline in FIG. 5. According to the HDD 100 of the present embodiment, the magnetic circuit 160a (i.e., a first magnetic circuit 160a described below) disposed in the operating region R of the actuator 140 and the magnetic circuit 160b (i.e., a second magnetic circuit 160b described below) disposed outside of the operating region R of the actuator 140 are formed to be different from each other in order to increase a number of windings of the magnetic circuits 160a and 160b included in the spindle motor 110.

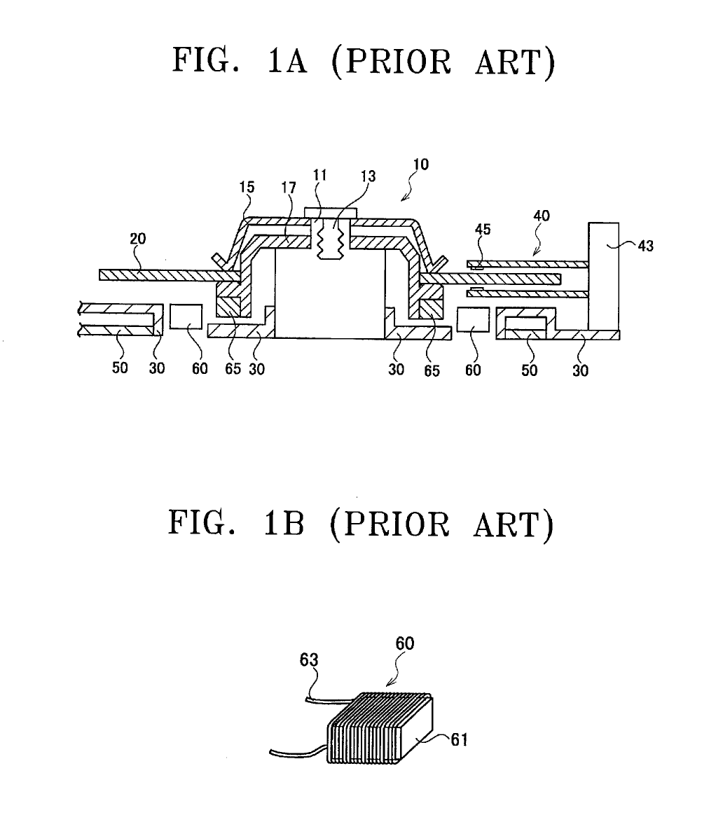

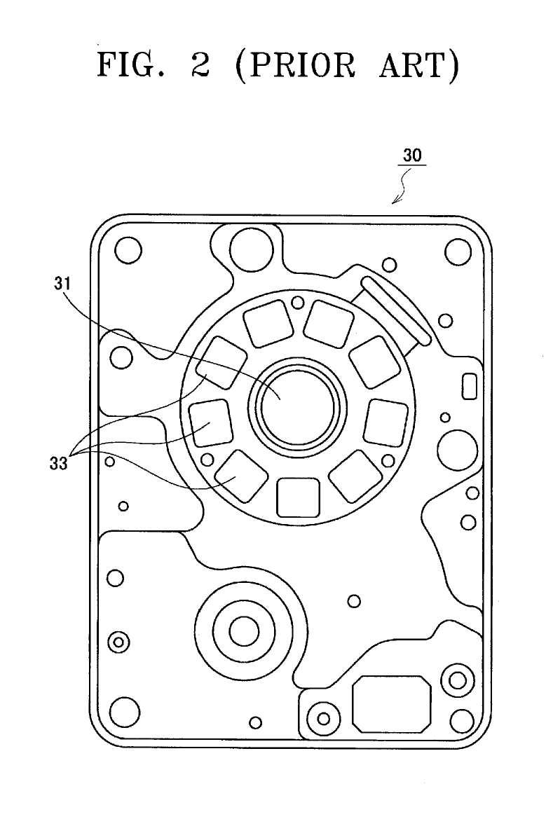

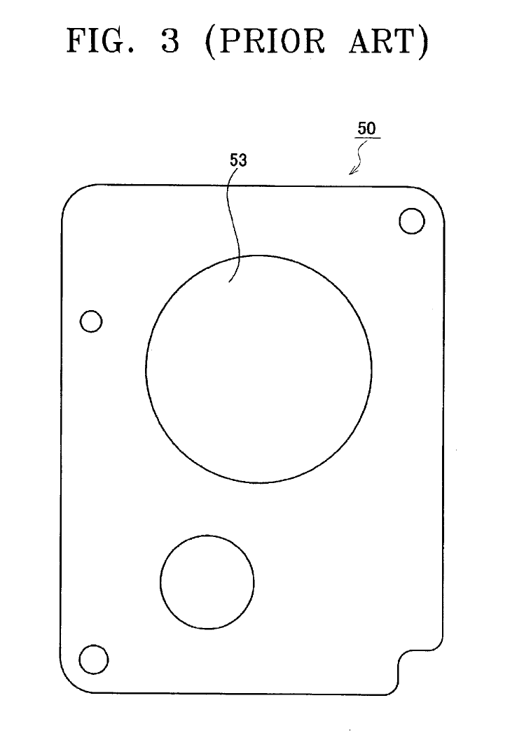

Hereinafter, features of the HDD 100 of various embodiments of the present general inventive concept will be described in comparison with those of the conventional HDD illustrated in FIGS. 1A through 3.

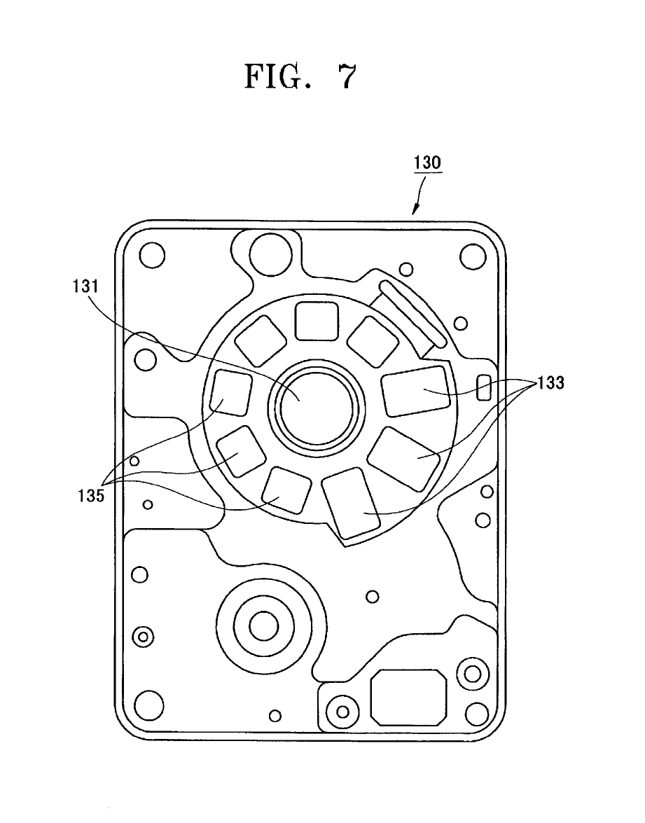

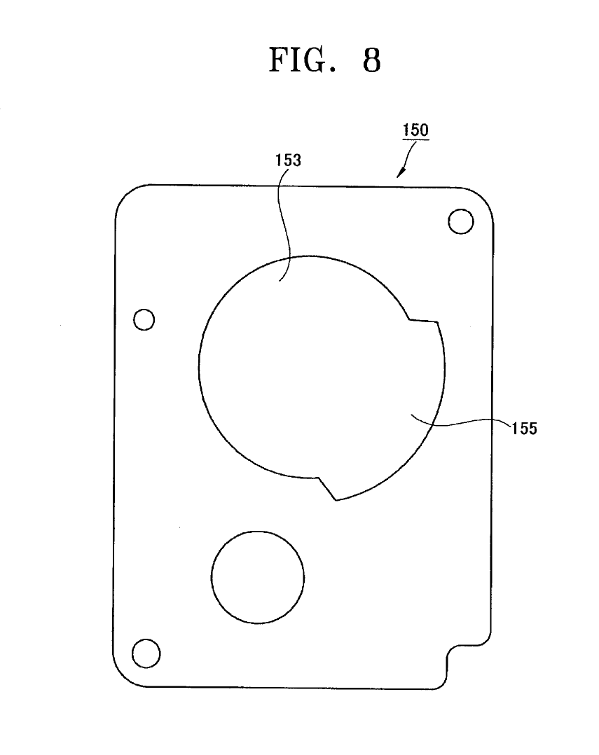

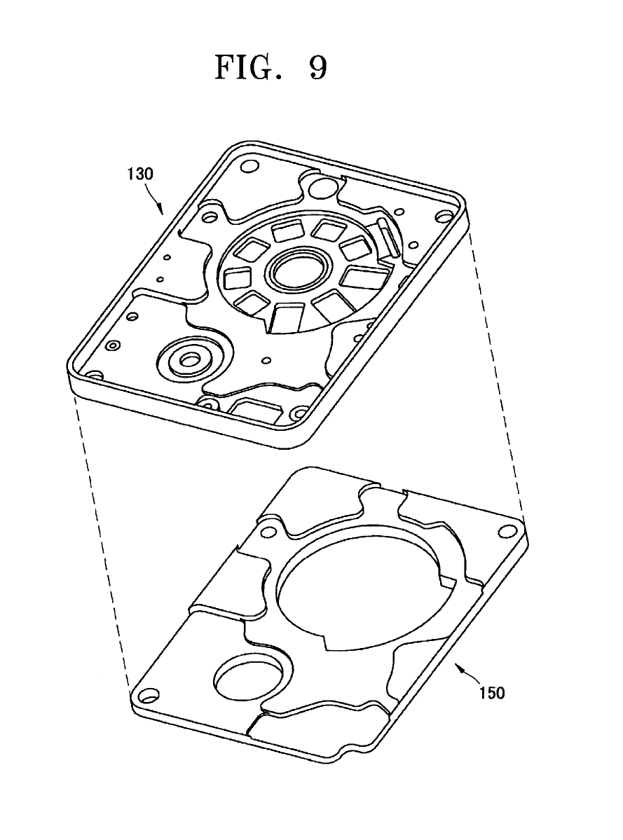

FIG. 6A is a partial cross-sectional view illustrating the HDD 100 of FIG. 4, FIG. 6B is an enlarged perspective view illustrating a first magnetic circuit 160a of FIG. 6A, and FIG. 6C is an enlarged perspective view illustrating a second magnetic circuit 160b of FIG. 6A. In addition, FIG. 7 is a plan view illustrating the base plate 130 of the HDD 100, according to an embodiment of the present general inventive concept, FIG. 8 is a plan view illustrating a circuit board 150 of the HDD 100, and FIG. 9 is an exploded perspective view of the base plate 130 and the circuit board 150 of the HDD 100.

In the HDD 100 of the present embodiment, the number of windings of wire 163a and 163b in the magnetic circuit(s) 160a and 160b is increased. Thus, a sufficient torque to rotate the disk 120 can be ensured without increasing a height or a thickness of the HDD 100 and without having to supply a large amount of electric current to the magnetic circuit(s) 160a and 160b of the spindle motor 110.

Referring to FIG. 6A, the HDD 100 includes the spindle motor 110, the disk 120, the base plate 130, the actuator 140, and the circuit board 150. The spindle motor 110 is a driving unit to rotate the disk 120. The spindle motor 110 can include the disk clamp 115 to clamp the disk 120 down from the upper portion thereof, the hub 117 to support the disk 120 from the lower portion thereof, and a fixing member 113 to fix the disk clamp 115 onto the spindle shaft 111. In addition, the magnet 165 is disposed in a portion of the hub 117 which faces the base plate 130, and a plurality of the magnetic circuits 160a and 160b are installed to correspond to the magnet 165.

In the HDD 100 of the present embodiment, the magnetic circuits 160a and 160b, the base plate 130, and the circuit board 150 are different from those of the conventional HDD.

In more detail, the magnetic circuits 160a and 160b formed around the spindle motor 110 include the first magnetic circuit 160a disposed in the operating region R (see FIG. 5) of the actuator 140, and the second magnetic circuit 160b disposed in an outer portion of the operating region R of the actuator 140 (i.e., outside the operating region R). Referring to FIG. 6B, the first magnetic circuit 160a is formed by winding the wire 163a on a core 161a. In addition, referring to FIG. 6C, the second magnetic circuit 160b is formed by winding the wire 163b on a core 161b.

The first magnetic circuit 160a extends further in a core direction (i.e., parallel to the base plate 130) when compared with the conventional magnetic circuit 60 (see FIG. 1B) and when compared with the second magnetic circuit 160b, because a controlling circuit, for example, is not placed on the circuit board 150 in the operating region R of the actuator 140. Therefore, a notch portion 155 (see FIG. 8) in which the first magnetic circuit 160a is installed can be formed on the circuit board 150 at a portion corresponding to the first magnetic circuit 160a that is installed in the operating region R of the actuator 140. Accordingly, the number of windings of the wire 163a of the first magnetic circuit 160a can be increased to be greater than that of the conventional HDD.

In addition, the second magnetic circuit 160b is expanded in the Z-axis direction (i.e., a height/thickness direction that is perpendicular to the core 161b and the base plate 130) in FIG. 6A, when compared with the conventional magnetic circuit 60 of FIG. 1B and when compared with the first magnetic circuit 160a. A gap between the disk 120 and the second magnetic circuit 160b disposed outside of the operating region R of the actuator 140 is larger than a gap in the operating region R of the actuator 140 (see FIG. 6A), since the actuator 140 takes up space within the gap. Therefore, the wire 163b can be double-wound around the core 161b as illustrated in FIG. 6C. Accordingly, the number of windings of the wire 163b can be increased.

As described above, the number of windings of the wire 163a of the first magnetic circuit 160a and the number of windings of the wire 163b of the second magnetic circuit 160b can be increased to be greater than the number of windings of the wire 63 of the conventional magnetic circuit 60 (see FIG. 1B). Therefore, a strong magnetic field can be generated by the first magnetic circuit 160a and the second magnetic circuit 160b, and the torque of the spindle motor 110 can be increased using the same electric current as an electric current used by the conventional HDD. For example, if the numbers of windings of the wires 163a and 163b of the first and second magnetic circuits 160a and 160b are two times larger than the number of windings of the wire 63 of the magnetic circuit 60 in the conventional HDD, the electric current can be reduced by about 60% from the electric current used in the conventional HDD and still generate the same torques as the conventional HDD. The number of windings of the wire 163a of the first magnetic circuit 160a and the number of windings of the wire 163b of the second magnetic circuit 160b may be equal to each other in order to make the strengths of the magnetic fields generated by the first and second magnetic circuits 160a and 160b equal to each other.

In the HDD 100 according to the present embodiment, shapes of the base plate 130 and the circuit board 150 can be manufactured according to the sizes of the first and second magnetic circuits 160a and 160b that are different from each other in order to reduce the height of the HDD 100.

The base plate 130 will be described as follows.

Referring to FIG. 7, the base plate 130 includes a penetration hole 131, in which the spindle motor 110 is installed. In addition, a plurality of first installation holes 133 and a plurality of second installation holes 135, in which a plurality of the first and the second magnetic circuits 160a and 160b are respectively installed, are formed along a peripheral portion of the penetration hole 131. Shapes of the first and second installation holes 133 and 135 correspond to the shapes of the first and second magnetic circuits 160a and 160b, respectively, and thus, the first installation hole 133 extends further in the core direction (i.e., the direction parallel to the base plate 130) when compared to the conventional magnetic circuit 60 (see FIG. 1B) and when compared to the second installation hole 135. Therefore, since the first and second magnetic circuits 160a and 160b are respectively disposed in the first and second installation holes 133 and 135, the first and second magnetic circuits 160a and 160b do not contact the base plate 130, and a height of the HDD 100 can be reduced.

Next, the circuit board 150 will be described as follows.

Referring to FIG. 8, the circuit board 150 according to the present general inventive concept includes a penetration hole 153 of circular shape in a portion where the spindle motor 110 is inserted, and a notch portion 155 formed on a boundary of the penetration hole 153 at a portion that corresponds to the first magnetic circuit(s) 160a. Therefore, the first and second magnetic circuits 160a and 160b do not contact the circuit board 150, and thus, the height of the HDD 100 can be reduced.

Referring to FIG. 9, the circuit board 150 having the structure described above is installed on a rear (i.e., a bottom) surface of the base plate 130. That is, the base plate 130 is installed on the circuit board 150.

The magnetic circuits 160a and 160b disposed in the HDD 100 of the present embodiment may include three first magnetic circuits 160a and six second magnetic circuits 160b, as illustrated by the shapes of the first and second installation holes 133 and 135 formed in the base plate 130 of FIG. 7. In the present embodiment, a three-phase spindle motor may be used, that is, U-phase, V-phase, and W-phase are combined to form a set, and the set combinations are formed to have the same shapes. Thus, the spindle motor 110 can be stably rotated. Therefore, the shapes and the number of the magnetic circuits 160a and 160b can be determined according to a number of phases of the spindle motor 110 and the operating region R of the actuator 140.

According to an HDD of the various embodiments of the present general inventive concept, a number of windings of wire on a core of magnetic circuits can be increased without increasing a height of the HDD. Therefore, sufficient torques of the spindle motor to rotate a disk can be ensured without increasing an electric current flowing in the wires of the magnetic circuits.

However, the present general inventive concept is not limited to the embodiments described above, for example, although one disk is illustrated in the HDD according to an embodiment described above, two or more disks can be disposed in the HDD. In addition, although the wire is described above as being twice-wound around the core of the second magnetic circuit, it should be understood that multi-layered wire can be wound if there is sufficient space.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A hard disk drive (HDD), comprising:
a disk;
a spindle motor to rotate the disk, the spindle motor including a spindle shaft, a plurality of magnetic circuits having cores and coils wound around the cores, the magnetic circuits being installed along a peripheral portion of the spindle shaft;
a base plate to support the spindle motor; and
an actuator to move a head that records and/or reproduces data to/from the disk,
wherein the magnetic circuits include a first magnetic circuit installed in an operating region of the actuator, and a second magnetic circuit installed outside of the operating region of the actuator, and the first magnetic circuit has a different shape than the second magnetic circuit.

2. The HDD of claim 1, wherein the first magnetic circuit has a larger length in a respective core direction parallel to the base plate than the second magnetic circuit, and the second magnetic circuit has a larger thickness in a direction perpendicular to the respective core direction and perpendicular to the base plate.

3. The HDD of claim 1, wherein the base plate includes a first installation hole, in which the first magnetic circuit is installed, and a second installation hole, in which the second magnetic circuit is installed.

4. The HDD of claim 1, further comprising:
a circuit board installed on a rear surface of the base plate and having a penetration hole with a substantially circular shape formed therein and in which the spindle motor is inserted, and a notch formed in an area of a peripheral portion of the penetration hole corresponding to the first magnetic circuit into which the first magnetic circuit is installed.

5. The HDD of claim 1, wherein a number of first magnetic circuits and a number of second magnetic circuits depends on a number phases of the spindle motor.

6. The HDD of claim 4, wherein a number of first magnetic circuits and a number of second magnetic circuits depends on a number of phases of the spindle motor.

7. A hard disk drive, comprising:
a base plate;
a spindle motor disposed on the base plate;
a disk to be rotated by the spindle motor;
a head stack assembly movable about the disk in an operating portion of the base plate;
at least one first circuit having a first shape disposed in the operating portion of the base plate; and
at least one second circuit having a second shape different from the first shape disposed in a non-operating portion of the base plate.

8. The hard disk drive of claim 7, wherein the at least one first circuit is disposed a first distance below the disk and the at least one second circuit is disposed a second distance below the disk, the second and first distances being different from one another.

9. The hard disk drive of claim 7, further comprising:
a circular magnet disposed around the spindle motor in the same horizontal plane as the first and second circuits such that operation of the first and second circuits generates a magnetic field with respect to the magnet to rotate the spindle motor.

10. The hard disk drive of claim 7, wherein the head stack assembly comprises:
a pivot disposed at an outer circumference of the disk;
an actuator arm attached at a first end thereof to the pivot and being movable about the pivot in a predetermined angular range that defines the operating portion; and
a magnetic head disposed at a second end of the actuator arm to read and write to the disk.

11. The hard disk drive of claim 7, wherein the base plate comprises:
a penetration hole through which a shaft of the spindle motor extends;
at least one first installation hole arranged about a first portion of a periphery of the penetration hole through which the at least one first circuit is installed; and
at least one second installation hole arranged about a second portion of the periphery of the penetration hole through which the at least one second circuit is installed.

12. The hard disk drive of claim 7, further comprising:
a circuit board disposed on a portion of the base plate opposite from the disk and having a penetration hole portion with a circular shape through which the spindle motor extends and a notch portion disposed around a periphery of the circular shape through which the at least one first circuit extends.

13. The hard disk drive of claim 7, wherein:
the at least one first circuit comprises a first ferromagnetic core having a first wire wound around the first core a first number of times; and
the at least one second circuit comprises a second ferromagnetic core having a second wire wound around the second core a second number of times, the second number of times being different from the first number of times.

14. The hard disk drive of claim 7, wherein the at least one first circuit is longer in a radial direction of the spindle motor than the at least one second circuit.

15. The hard disk drive of claim 7, wherein the at least one second circuit is thicker than the at least on first circuit.

16. A hard disk drive, comprising:
a base plate having a first penetration hole to accommodate a spindle motor and different size installation holes arranged around a periphery of the first penetration hole; and
a circuit board disposed at a rear side of the base plate and having a second penetration hole corresponding to the first penetration hole to accommodate the spindle motor.

17. The hard disk drive of claim 16, wherein the second penetration hole comprises a circular portion that corresponds to installation holes of a first shape and a notch portion disposed at a periphery of the circular portion that corresponds to installation holes of a second shape.

18. The hard disk drive of claim 17, wherein the second installation holes are longer along a radial direction of the first penetration hole in the base plate.

19. The hard disk drive of claim 16, further comprising:
a spindle motor extending through the first and second penetration holes;
a magnet disposed around a shaft of the spindle motor; and
a plurality of magnetic circuits having different shapes extending through corresponding ones of the installation holes in the base plate and through the second penetration hole in the circuit board, the magnetic circuits being arranged on the same radial axes with respect to the shaft of the spindle motor as the magnet.

20. A spindle motor assembly usable in a hard disk drive, the assembly comprising:
a base plate;
a rotatable hub disposed on the base plate to support a disk;
a magnet disposed around a base of the hub;
one or more first magnetic circuits disposed around a first circumferential portion of the hub to generate a first magnetic field with respect to the magnet; and
one or more second magnetic circuits disposed around a second circumferential portion of the hub to generate a second magnetic field with respect to the magnet.
